(19) United States
(12) Patent Application Publication
(10) Pub. No.: US 2011/0210273 A1
(43) Pub. Date: Sep. 1, 2011

(54) UV LAMP

(75) Inventors: Ralph Kurt, Eindhoven (NL); Elvira Johanna Maria Paulussen, Reppel-Bocholt (BE); Bastiaan Uitbeijerse, Helmond (NL); Marco Van As, Waalre (NL); Rene Theodorus Wegh, Veldhoven (NL)

(73) Assignee: KONINKLIJKE PHILIPS ELECTRONICS N.V., EINDHOVEN (NL)

(21) Appl. No.: 13/128,248

(22) PCT Filed: Nov. 6, 2009
(86) PCT No.: PCT/IB2009/054938

§ 371 Date: May 9, 2011

(30) Foreign Application Priority Data
Nov. 14, 2008 (EP) 08169116.4

(51) Int. Cl. G01J 3/10

(52) U.S. Cl. 250/504 R

(57) ABSTRACT

The invention relates to an UV lamp (100) that may for example be used as a torch for crime inspection. The UV lamp (100) comprises a light source (50), e.g. an UV LED, and a reflector (30) which are designed such that a light spot comprising an inner region of a given minimal diameter D at an axial distance of about 8-D is produced which has an intensity variation of less than about 20%. The reflector (30) may preferably be a Compound Parabolic Concentrator (CPC) with a high aspect ratio. Moreover, the UV lamp (100) may comprise a luminescent indicator for making activity of the UV lamp visible to a user.

### FIELD OF THE INVENTION

The invention relates an UV lamp with a light source and a reflector.

### BACKGROUND OF THE INVENTION

The U.S. Pat. No. 7,214,952 B2 discloses an UV torch that can for example be used for crime investigations. The torch comprises UV LEDs that are disposed inside a broad reflector having an aspect ratio (ratio between width and length) of about 1:1.

### SUMMARY OF THE INVENTION

Based on this situation it was an object of the present invention to provide an UV lamp with improved operating characteristics.

This object is achieved by an UV lamp which may for example be used for non destructive testing, leakage, and crime scene investigations and which will typically be designed as a handheld torch. The UV lamp comprises the following two components:
a) A reflector with an entrance window and with an exit window larger than the entrance window, wherein light leaves the reflector through the exit window along an optical axis during operation of the lamp.
b) A light source that is disposed at the entrance window of the aforementioned reflector for emitting ultraviolet (UV) light into the reflector. The light source may for example be realized by Light Emitting Diodes (LEDs).

Moreover, the geometry of the reflector and of the light source are such that the light source can produce during operation of the UV lamp a light spot comprising an inner region that has at least a given minimal radial diameter D at an axial distance of about 8·D from the lamp (e.g. measured from the exit window), said inner region having an intensity variation of less than about 20%, preferably less than about 10%. In this context, the term “axial” refers to the optical axis, the term “radial” to a direction perpendicular thereto. Moreover, the “intensity variation” is defined as the difference between the maximal intensity and the minimal intensity that occur inside the inner region in relation to (i.e. as a percentage of) the average intensity in the inner region. It should be noted that the output beam of the UV lamp may have a cross section different from a circle (the light spot produced by this beam may for example be defined as usual by the area in which the intensity is more than 50% of the maximal intensity) and that the mentioned (circular) “inner region” shall only be comprised by the spot. The given minimal diameter D of the inner region for which the above relation holds may typically range between 80 mm and 120 mm.

The described UV lamp provides a homogeneous illumination of UV light with a large relative diameter, which is advantageous in applications as for example crime inspection. The homogeneity guarantees that every point illuminated by the inner region of the spot receives a sufficient intensity, thus avoiding the risk that for example critical traces are overlooked.

The average intensity in the inner region of the produced light spot is preferably at least 1 mW/cm². This allows for a sufficient illumination in the mentioned applications like non destructive testing, leakage, and crime scene investigations.

According to a preferred embodiment of the UV lamp, the intensity distribution is not only highly homogeneous inside the considered inner region of the spot, but also comparatively sharp. In particular, the UV light intensity during operation of the lamp at radial distances of more than 1·D from the optical axis (spot center) in a plane that comprises the considered spot is preferably less than about 50%, most preferably less than 20% of the average UV light intensity inside the inner region of the spot. Thus the intensity is substantially constant over a radial distance from the optical axis between zero and D/2 and then drops by more than 50% between D/2 and D.

The required homogeneity of the intensity inside the inner region of diameter D is preferably not only valid at the axial distance of 8·D, but over a range between about 3·D and 20·D, preferably over a range between about 6·D and 10·D from the exit window of the reflector. Thus the homogeneous UV illumination can be used in a sufficiently large working range of the UV lamp.

The length of the reflector is preferably more than about 1.8 times the diameter of its exit window, i.e. the reflector is built with a large aspect ratio.

The exit window of the reflector has preferably a diameter in the range from 15 mm to 20 mm. If the exit window is not circular, its “diameter” may for example be defined by the diameter of the largest circle that completely fits into the exit window.

There are different possibilities for a geometrical design of the reflector and the light source that yield an UV lamp according to the present invention. In a particularly preferred embodiment, the reflector has approximately or exactly the shape of a “Compound Parabolic Concentrator” (CPC). In its cross section, a CPC is composed of two parabolic segments with different focal points. Detailed descriptions of CPCs can be found in literature (e.g. W. T. Welford, R. Winston, “High Collection Nonimaging Optics”, Academic Press Inc (1990)). It should be noted that a shape of the reflector is considered as being “approximately a CPC” if it lies within a volume around an exact CPC geometry having a thickness of about 5% the diameter of the reflector's exit window.

According to an alternative embodiment, the reflector may be described (in a cross section that comprises the optical axis) by a Bézier curve with a slope of zero at the exit window. The Bézier curve may particularly be described by formulae (1) to (3) of FIG. 8 for n=2 with (all lengths measured in arbitrary units, e.g. mm):
a weight w₁ of about 0.5±0.2, particularly 0.453,
a position ξ₁ of about 0.8±0.32, particularly 0.826,
a size χ₁ of about 8.7±2, particularly 9.05,
a rear size R of about 8.7±2, particularly 9.05,
a front size F of about 2.25,
and a length L of 40.

Such a design is particularly favorable in combination with a light source that is placed outside the reflector at a (small) distance in front of the entrance window.

The reflector may optionally be rotationally symmetric about its optical axis.

According to another embodiment, the reflector may be segmented, i.e. composed of a number N≧3 of segments, each of them rotated by 360°/N about the optical axis.

Moreover, the reflector may be facetted, i.e. consists of a plurality of small planar pieces (facets).

In general, the reflector may comprise on its reflective surface any material with a sufficient reflectivity for the emitted UV light. Preferably, the reflector comprises for example aluminum (Al) on its reflective surface, with a reflectivity of more than 85% for UV light.

The light source is preferably disposed outside the reflector, thus allowing a design that can readily be assembled and that is compatible with the use of LEDs.

Moreover, the light source has preferably an emission spectrum that lies primarily (i.e. with more than 90% of its energy) between wavelengths of 350 nm and 380 nm. Thus emission in a narrow band of interest can be achieved and no energy is lost.

The heat that it is produced during the operation of the light source may preferably be absorbed and distributed by the reflector, which will thus simultaneously function as a heat sink in the UV lamp.

The invention further relates to an UV lamp with an UV light source and a luminescent indicator that can be excited by the UV light of the light source. Preferably, said indicator is visibly mounted in the path of the output light beam of the UV lamp. When the lamp is operated, UV light will fall on the indicator and excite its luminescence which is assumed to occur in the visible range of the electromagnetic spectrum. An activity of the light source can then readily be detected by a user from the resulting radiance of the indicator though the UV light of the light source itself is invisible. Thus a considerable increase in safety can be achieved as an inadvertent, unnoticed exposure to UV light is prevented. It should be noted that such an UV lamp constitutes an independent, autonomous aspect of the present invention.

The luminescent indicator can particularly be realized in combination with an UV lamp of the kind described above, i.e. with an UV light source and a reflector having the preferred homogeneous spot illumination. In this case, the luminescent indicator is preferably disposed in the reflector (most preferably near the exit window) or at a transparent cover that shields the exit window of the reflector.

### BRIEF DESCRIPTION OF THE DRAWINGS

These and other aspects of the invention will be apparent from and elucidated with reference to the embodiment(s) described hereinafter. These embodiments will be described by way of example with the help of the accompanying drawings in which:

FIG. 1 schematically shows a section through a first UV lamp according to the present invention;

FIG. 2 shows an enlarged perspective section through the exit window of the reflector of the first UV lamp;

FIG. 3 schematically shows a section through a second UV lamp with a luminescent indicator at the top end of the reflector;

FIG. 4 shows an exploded perspective view of an UV lamp according to the present invention;

FIG. 5 illustrates the radial intensity profile of the output light beam of the UV lamp at three different axial distances;

FIG. 6 illustrates a cross section through a reflector with a CPC design;

FIG. 7 illustrates a cross section through a reflector with straight walls;

FIG. 8 illustrates formulae that can be used to describe a reflector shape;

FIG. 9 shows measurement results of the UV intensity obtained in a spot at 38 cm distance when the LED is driven with different currents.

Like reference numbers or numbers differing by integer multiples of 100 refer in the Figures to identical or similar components.

### DESCRIPTION OF PREFERRED EMBODIMENTS

UV emitting, handheld and battery-powered torches or lamps are for example useful in forensic applications (e.g. for locating evidence like fingerprints or traces of blood at a scene of a crime) or for nondestructive testing of materials. In this context, it was the object of the present invention to provide an UV lamp with improved characteristics, especially a better quality of the resulting UV spot with respect to its intensity, its homogeneity, and its size at various distances. Several embodiments of an UV lamp that achieve these objectives are described in more detail in the following.

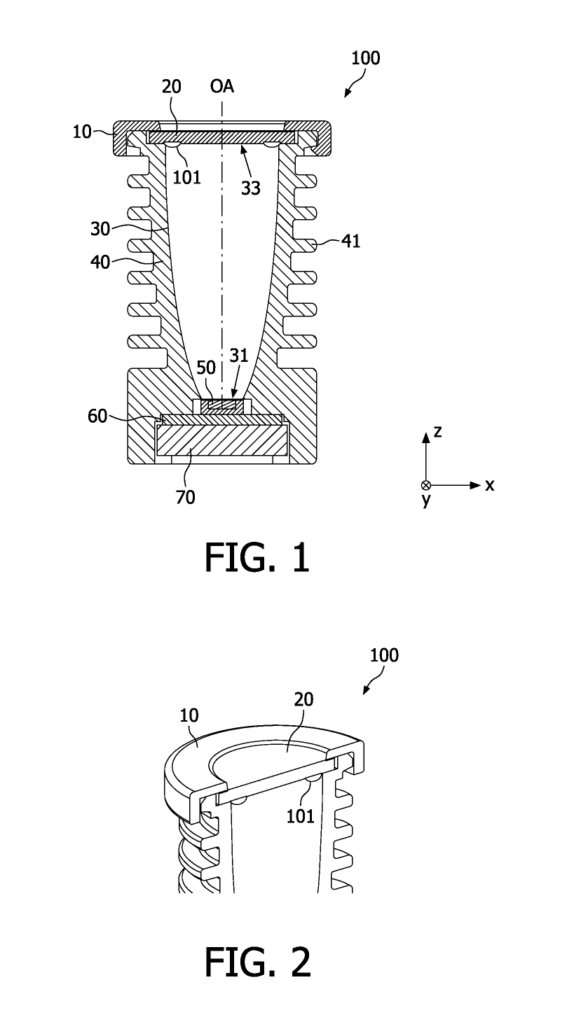

Thus FIGS. 1 and 2 show in a section along its optical axis OA (parallel to the z-axis) a first embodiment of an UV lamp 100 according to the present invention. In the sequence from top to bottom, i.e. opposite to the emission direction, said UV lamp 100 comprises the following components:
A front cover 10, for example a molded plastic part (PA).
A glass window 20 that is transparent for UV. The window 20 may particularly comprise a quartz or an alkali free glass (such as AF 45), with a typical thickness of about 2 mm.
A reflector 30 with a small entrance window 31 at the bottom and a larger exit window 33 at the top. The exit window 33 is mechanically closed by the glass window 20, which is held in place and attached to the reflector 30 by the front cover 10, to protect said reflector from contamination and damage.
A housing 40 that is integrally built around the reflector 30 and comprises radially extending ribs 32 via which heat can be dissipated.
A high-power UV Light Emitting Diode (LED) 50 that is disposed outside the reflector 30 in front of the entrance window 31. In a preferred embodiment said LED has a relatively small emission spectrum at about 365 nm (between 350 and 380 nm), and its optical output power is at least about 250 mW (for example achievable with a UV LED model NCSU033AT from Nichia Corporation, TOKUSHIMA, JAPAN).
A printed circuit board 60, particularly a MCPCB (Metal Core Printed Circuit Board) on which the UV LED 50 is mounted.
A heat spreading block 70, preferably made of copper Cu, that is mechanically and thermally coupled to the housing 40.

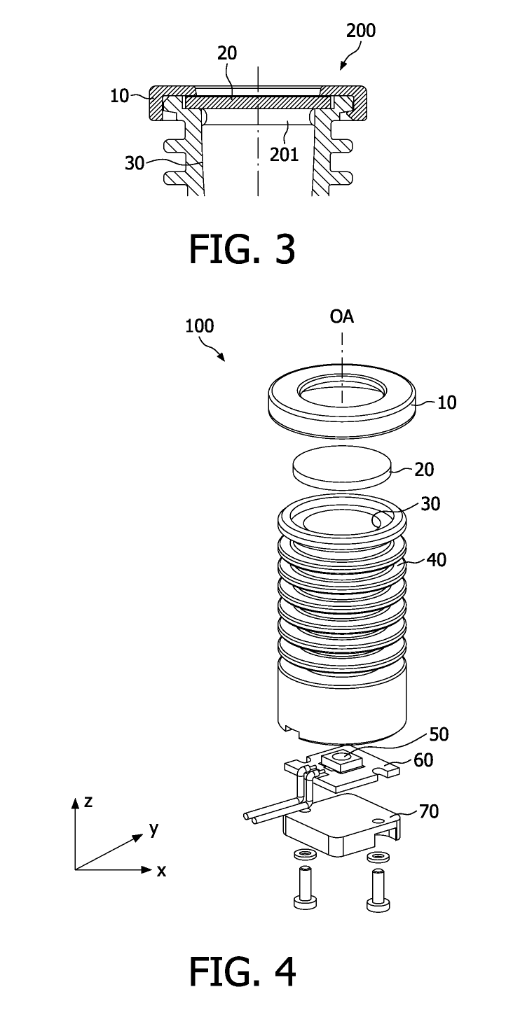

FIG. 3 shows a partial section through a second embodiment of an UV lamp 200 which differs from the first embodiment only with respect to fluorescent indicators 201 and 101, respectively, that will be described in more detail below.

FIG. 4 shows an exploded perspective view of the first (or second) UV lamp.

The described UV-LED lamps 100, 200 of FIGS. 1 to 4 are characterized by a substantially homogeneous light spot which has an inner region with less than 20%, preferably less than 10% intensity variation at a distance of about 38 cm from the exit window of the lamp.

The diameter of the aforementioned inner region of the spot at about 38 cm is typically ≧70 mm, preferably ≧80 mm, and most preferably ≧90 mm. The intensity in the inner region of the spot is typically ≧1 mW/cm², preferably ≧2 mW/cm², most preferably ≧3 mW/cm².

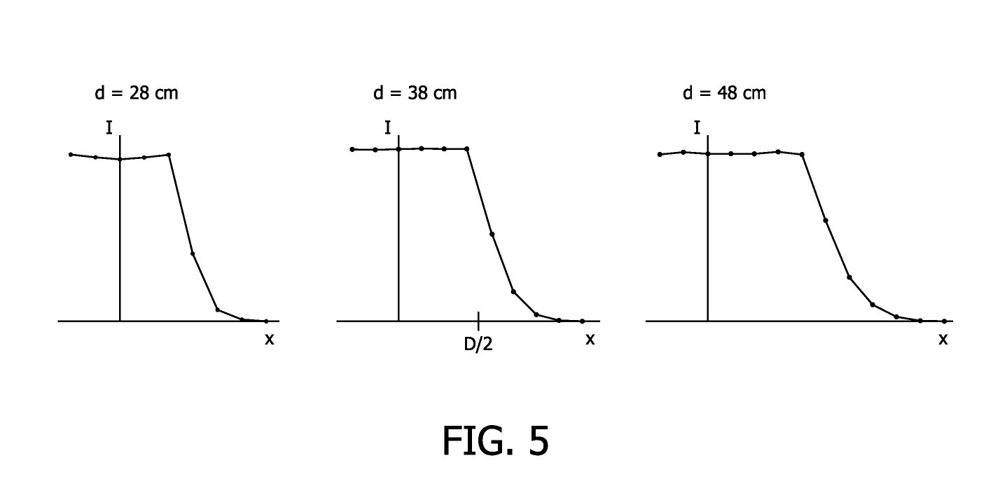

FIG. 5 shows shapes of the spot produced by the UV lamp that have been calculated and experimentally observed as intensity profiles along the x-axis. In the spot with a diameter D of about 10 cm, which is observed at an axial distance d=38 cm from the lamp, an UV intensity I of 1.5 mW/cm² was measured. The intensity profile shows that the intensity I in the inner region of the spot is very homogeneous (nearly constant). It should be noted in this context that “the spot” may be defined by the full width at half maximum (FWHM), i.e. the area in which the intensity is ≧50% of the maximal intensity. The aforementioned homogeneously illuminated inner region of such a spot will then typically cover more than 40%, preferably more than 50% of the spot area.

The UV LED and the reflector are further designed in a way that at distances d of 28 cm and 48 cm from the lamp still a homogeneous spot is obtained. In commonly used reflectors, the spot shape and intensity change dramatically as function of the distance, which is undesirable for e.g. an inspection application.

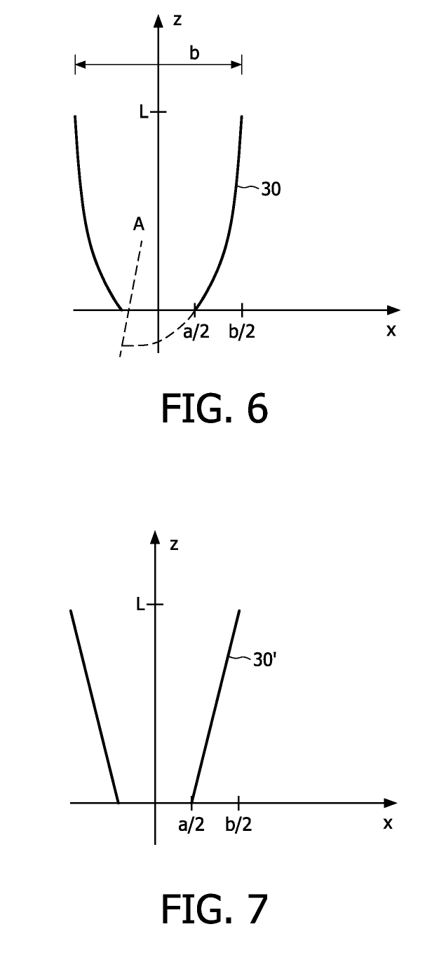

FIG. 6 shows schematically a section through a preferred reflector 30 for an UV lamp according to the invention. This optical reflector 30 is characterized by an elongated shape with a length L of more than two times (preferably between 2 and 2.5 times, most preferably about 2.2 times) the diameter b of said reflector at its exit window. Moreover, said reflector is characterized by a small exit diameter b between 15 mm and 20 mm, preferably of about 18 mm. The length L of the reflector is typically about 40 mm.

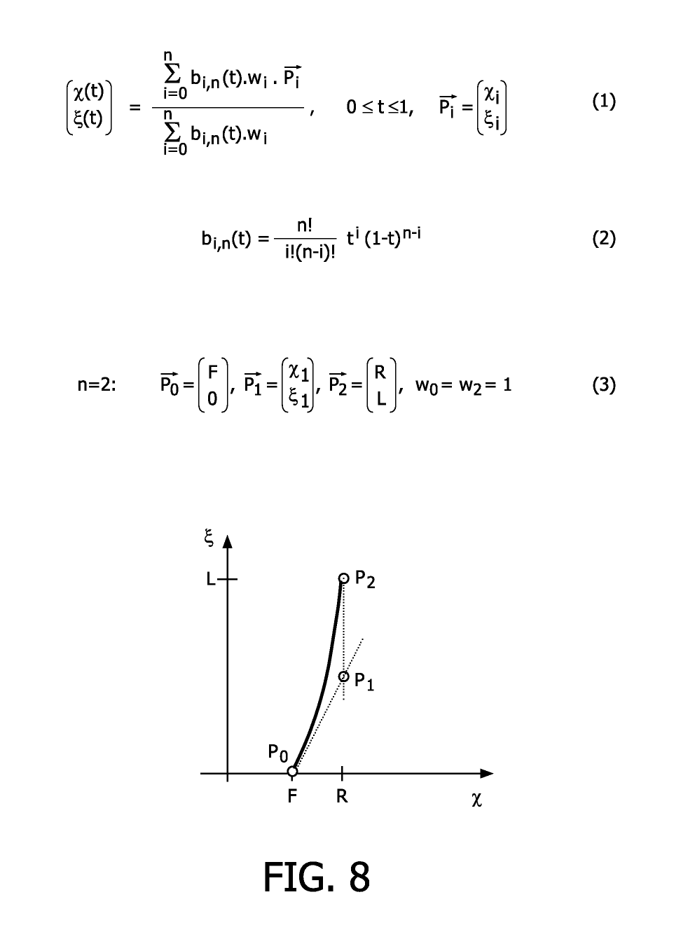

Substantially the reflector geometry is derived from a CPC (Compound Parabolic Concentrator). In this context, reference is made to FIG. 8 that illustrates a possible mathematical description of reflector shapes with the help of rationale Bézier functions. Formulae (1) and (2) refer to the general case, while formula (3) specifies for the case n=2 the parameters that are considered to be fixed or variable, respectively. A CPS geometry can be described with these formulae (1) to (3) by the following values for the variable parameters:
weight w₁: 0.50,
position ξ₁: 0.794 mm,
size χ₁: 8.693 mm,
rear size R: 8.693 mm,
front size F: 2.25 mm,
length L: 40 mm.

Such a CPC gives perfect spot results for a homogenously filled entrance window (i.e. the region ξ=0 and −F≦χ≦F in FIG. 8). Due to the LED packaging, this is however not achievable for the described real UV lamps 100, 200. Instead, the UV LED emitter is typically small (about 1 mm×1 mm) and has to be placed at least about 1 mm below the entrance window of the reflector. The reflector is therefore preferably modified in order to obtain a spot as described above. This optimized reflector can be described by a Bézier curve according to formulae (1) to (3) of FIG. 8 with the following variable parameters (with slope of the curve at the exit window being zero):
weight w₁: 0.453,
position ξ₁: 0.826 mm,
size χ₁: 9.057 mm,
rear size R: 9.057 mm,
front size F: 2.25 mm,
length L: 40 mm.

The half opening angle of the beam that is emitted by such a reflector can be specified to be smaller than 20°, preferably smaller than 15°, and most preferably smaller than 10°.

The reflector 30 shown in FIG. 6 consists of parabolic sections that define an entrance window of width a and an exit window of width b for a reflector of length L. For the right branch of the reflector 30, the corresponding axis A of the parabola and a prolongation until the apex of the parabola are indicated by dotted lines.

FIG. 7 shows in a similar diagram as FIG. 6 a CPC reflector 30′ with straight reflective surfaces.

In general, the reflector of an UV lamp according to the invention may be rotationally symmetric about the optical axis OA and have a reflectivity above 85%, preferably above 90%, most preferably above 95% for UV light at 365 nm and at angles of incidence in the typical range between 65 and 85° with respect to normal. In a preferred embodiment said reflector comprises Al (i.e. consist of Al or is coated with Al).

In another preferred embodiment, said reflector may be segmented, i.e. have a triangular, rectangular, square, hexagonal or polygon shape (with e.g. N=4, 6, 8 corners). It might be composed of for example 4, 6 or 8 highly reflective, thin, deformable, Al parabolic foils (e.g. MIRO® foils available from Alanod-Solar GmbH & Co. KG, Ennepetal, Germany) with corresponding mechanical support.

In yet another embodiment the reflector may be facetted to improve further the quality of the beam.

Moreover, the housing 40 around the reflector 30 can be used as heat sink, wherein sufficiently good thermal interfaces between the UV LED 50 and the PCB 60, as well as the heat spreader 70 and the heat sink are provided. This is particular useful if thermal management of the UV-LED module is applied in an UV torch.

The UV LED 50 may preferably be driven with DC current, for example at 3.6 V and a current between 200 mA and 700 mA, preferably between 400 mA and 600 mA, most preferably at about 500 mA. Said driver current may be provided from batteries or rechargeable batteries and might be stabilized by an additional current stabilizing electronic circuit.

In another preferred embodiment the UV lamp is operated at different optical power output levels (adjustable by the user) to optimally use contrast.

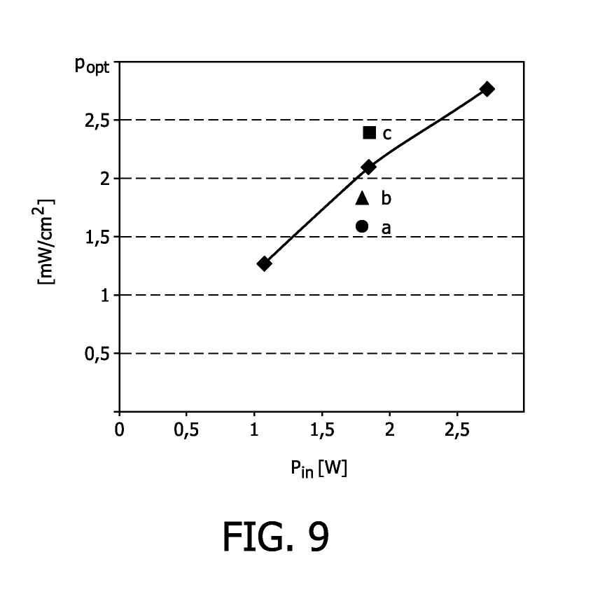

FIG. 9 shows in this respect measurement results of the optical power density pᵢₙ of UV light obtained with a UV LED lamp according to the invention in a spot at 38 cm distance when the LED is driven with different currents, i.e. with different electrical input powers Pᵢₙ. Data points a and b correspond to a state-of-the-art reflector with and without exit window, respectively. Data point c corresponds to the UV LED lamp of the invention when the exit window (AF45) is removed.

In summary, an UV LED lamp was described comprising a high power UV LED 50, an optical reflector 30, a MCPCB 60, a heat spreader 70, a heat sink 40, a housing 40, a protection window 20, and electrical connectors. The optical reflector is characterized by an elongated parabolic shape (substantially a modified CPC) with a length of more than two times the diameter of said reflector. The UV-LED lamp is furthermore characterized by a substantially homogeneous spot with less than 20% variation at a distance of 38 cm from the module.

In the following, further embodiments of the present invention will be described that, though explained here in connection with the above embodiments of an UV lamp with homogeneous spot characteristics, constitute an independent aspect of the invention. This aspect is related to the problem that in conventional UV lamps one cannot directly see with the eyes whether the lamp is in operation. This increases the risk of dangerous situations, such as damage of eyes or burning skin or other tissue. Intense ultraviolet light absorbed by the eye can for example cause a superficial and painful keratitis, with the risk of permanent damages (known e.g. as arc eye, arc flash, welder's flash, corneal flash burns, or flash burns).

It is therefore desirable to have an UV lamp with means to protect a user against inadvertent exposure to UV light.

To achieve this, an UV lamp is proposed with an indicator that allows the user to easily and directly see whether said UV lamp is in operation. Consequently the risk of dangerous situations such as e.g. exposing the eye(s) unintentionally or unconsciously to UV irradiation is reduced.

A first embodiment of an appropriate indicator 101 is shown in FIGS. 1 and 2. The indicator 101 comprises or consists of a fluorescent material (e.g. a suitable phosphor) that is integrated e.g. into or onto parts of the protective window 20. Alternatively, the fluorescent material of said fluorescent indicator may be embedded in a ceramic, such as known from Philips Lumiramics or Lumifilms.

According to another preferred embodiment, a fluorescent indicator 201 is applied onto the outer rim of the reflector 30 as schematically indicated in FIG. 3.

The fluorescent material of the indicator 101 or 201 may substantially emit light in the visible range, preferably at wavelengths ≧500 nm, more preferably ≧550 nm, most preferable ≧600 nm, i.e. light is emitted in white or better red, orange, green. Large wavelengths (red/orange) are preferred in order to prevent that they can excite fluorescent outside the UV beam. Red phosphor has for example the advantage that it cannot excite any other compound. Red LED phosphors like sulfides and nitrides, that have been developed to be excited by blue light, can be used for this purpose as well since they exhibit a broad excitation spectrum extending into the UV. Examples are: (Ba,Sr,Ca)AlSiN₃:Eu, (Ba,Sr,Ca)₂Si₅N₈:Eu and (Ba,Sr,Ca)S:Eu, all emitting in the red-amber region.

In addition, green-yellow phosphors such as (Ba,Sr,Ca)Si₂N₂O₂:Eu, (Ba,Sr,Ca)₂SiO₄:Eu, (Ba,Sr,Ca)Ga₂S₄:Eu can be used as well since they also exhibit a broad excitation band. Typical red emitting phosphors such as SNE could be used with a phosphor weight/density of between 0.5 and 20 g/m², preferably between 1 and 10 g/m², and most preferably about 5 g/m² (when applied in transmissive mode).

A coating of e.g. a Philips lumiramics or a lumifilm on a part of the UV lamp may have a thickness between 5 and 60 μm, preferably between 10 and 30 μm.

The phosphor can be applied via coating on a flexible substrate and folding that inside the lamp as a ring, or can be coated or printed immediately on appropriate parts of the lamp. Alternatively, an autonomous component like a ring can be fabricated by e.g. injection molding.

The luminescent indicator should be visible substantially from any angle (also outside the UV spot), but its intensity should be sufficiently low to prevent “interference” with the UV beam and/or the purpose of the UV lamp.

The UV lamp with the luminescent indicator has preferably a relatively sharp UV spot with a high intensity in the spot and a very low intensity outside. Visible light should have very low intensity in or close to the UV spot (e.g. less than 5% but more than 0.1%, preferably less than 2%, more preferably less than 1% of UV intensity), and a broad distribution, e.g. a Lambertian or Gaussian-like distribution. The angular distribution of the visible light should not show sharp changes, as the eye perceives this as rings.

In summary, it is proposed to equip the optics of an UV lamp module with means (such as fluorescent material integrated e.g. into or onto parts of the protective window, parts of the reflector or the lens system) in order to allow easily visible indication of the status of the module, i.e. whether it is switched ON or OFF.

Finally it is pointed out that in the present application the term “comprising” does not exclude other elements or steps, that “a” or “an” does not exclude a plurality, and that a single processor or other unit may fulfill the functions of several means. The invention resides in each and every novel characteristic feature and each and every combination of characteristic features. Moreover, reference signs in the claims shall not be construed as limiting their scope.

1. An UV lamp (100, 200), comprising:
a) a reflector (30) with an optical axis (z), an entrance window (31) and a larger exit window (33);
b) a light source (50) that is disposed at the entrance window of the reflector for emitting UV light into the reflector;
wherein the light source can produce during operation a light spot comprising an inner region of a given minimal diameter D at an axial distance of about 8·D from the lamp that has an intensity variation of less than about 20%.

2. The UV lamp (100, 200) according to claim 1,
characterized in that the average intensity in said inner region is ≧1 mW/cm².

3. The UV lamp (100, 200) according to claim 1,
characterized in that the intensity at a radial distance of more than D from the optical axis (z) is less than 50% of the average intensity in said inner region.

4. The UV lamp (100, 200) according to claim 1,
characterized in that the intensity variation inside said inner region is less than 20% for all axial distances of that inner region between 6·D and 10·D.

5. The UV lamp (100, 200) according to claim 1,
characterized in that length (L) of the reflector (30) is more than about 1.8 times the diameter (b) of the exit window (33).

6. The UV lamp (100, 200) according to claim 1,
characterized in that the diameter (b) of the exit window (33) of the reflector (30) ranges between 15 mm and 20 mm.

7. The UV lamp (100, 200) according to claim 1,
characterized in that the reflector (30) has at least approximately the shape of a Compound Parabolic Concentrator.

8. The UV lamp (100, 200) according to claim 1,
characterized in that the reflector (301 is described by a Bézier curve according to the formulae
$$\begin{matrix}( \begin{matrix}χ ( t ) \\ ξ ( t )\end{matrix} ) = \frac{{\sum }_{i = 0}^{n} {b}_{i , n} ( t ) \cdot {w}_{i} \cdot {\vec{P}}_{i}}{{\sum }_{i = 0}^{n} {b}_{i , n} ( t ) \cdot {w}_{i}} , 0 \leq t \leq 1 , {\vec{P}}_{i} = ( \begin{matrix}{χ}_{i} \\ {ξ}_{i}\end{matrix} ) & ( 1 ) \\ {b}_{i , n} ( t ) = \frac{n !}{i ! ( n - i ) !} {{t}^{i} ( 1 - t )}^{n - i} & ( 2 ) \\ n = 2 : {\vec{P}}_{0} = ( \begin{matrix}F \\ 0\end{matrix} ) , {\vec{P}}_{1} = ( \begin{matrix}{χ}_{1} \\ {ξ}_{1}\end{matrix} ) , {\vec{P}}_{2} = ( \begin{matrix}R \\ L\end{matrix} ) , {w}_{0} = {w}_{2} = 1 & ( 3 )\end{matrix}$$
with:
a weight w₁ of about 0.5±0.2, particularly 0.453,
a position ξ₁ of about 0.8±0.32, particularly 0.826,
a size χ₁ of about 8.7±2, particularly 9.05,
a rear size R of about 8.7±2, particularly 9.05,
and a front size F of about 2.25.

9. The UV lamp (100, 200) according to claim 1,
characterized in that the reflector (30) is rotationally symmetric.

10. The UV lamp (100, 200) according to claim 1,
characterized in that the reflector (30) is segmented and/or facetted.

11. The UV lamp (100, 200) according to claim 1,
characterized in that the light source (50) is disposed outside the reflector (30).

12. The UV lamp (100, 200) according to claim 1,
characterized in that the light source (50) has an emission spectrum primarily between 350 nm and 380 nm.

13. The UV lamp (100, 200) according to claim 1,
characterized in that the reflector (30) is designed as a heat sink for the light source (50).

14. An UV lamp (100, 200), particularly according to claim 1,
characterized in that it comprises a luminescent indicator (101, 201) that is excited by UV light.

15. The UV lamp (100, 200) according to claim 14,
characterized in that the luminescent indicator (101, 201) is disposed in the reflector (30) or at a cover glass (10) of the exit window (33) of the reflector (30).
